(19) United States
(12) Patent Application Publication
(10) Pub. No.: US 2016/0036638 A1
(43) Pub. Date: Feb. 4, 2016

(54) PROVISIONING

(71) Applicants: Allied Telesis Holdings Kabushiki Kaisha, Tokyo (JP); ALLIED TELESIS, INC., Bothell, WA (US)

(72) Inventors: Graeme Keith Campbell, Christchurch (NZ); Michael Owen Savory, Christchurch (NZ); Gregory James Hoggarth, Christchurch (NZ); Samuel Gordon Varley, Christchurch (NZ)

(21) Appl. No.: 14/446,235

(22) Filed: Jul. 29, 2014

(51) Int. Cl. H04L 12/24

(52) U.S. Cl. CPC H04L 41/0846; H04L 41/0806

(57) ABSTRACT

Systems, apparatus and methods described herein are configured for creating or generating a configuration for a device that is to be newly added to a network and configured for configuration (e.g., automatic) of the device. In some embodiments, the systems, apparatus and methods described herein are further configured for setting up on or more devices to provide information about a configuration (e.g., location) and hostname or other identifier to the newly added network device.

### RELATED U.S. CASES

This application is related to U.S. patent application Ser. No. 13/754,680 entitled “SAFE STATE FOR NETWORKED DEVICES”, by Mark A. McKinstry, et al., (Attorney Docket No. 13-001-00-US), filed on 30 Jan. 2013, which claims the benefit of U.S. Provisional Patent Application Nos. 61/592,341, filed on 30 Jan. 2012 and 61/745,541, filed on 21 Dec. 2012. The related applications are incorporated by reference herein.

This application is related to U.S. patent application Ser. No. 14/183,448 entitled “AN AUTOMATED COMMAND AND DISCOVERY PROCESS FOR NETWORK COMMUNICATIONS”, by Geoff McCaughan, et al., (Attorney Docket No. 13-008-00-US), filed on 18 Feb. 2014, which is incorporated by reference herein.

This application is related to New Zealand Application Number 607298 entitled “SCALABLE UNIFIED COMMAND LINE INTERFACE,” by Geoffrey Douglas McCaughan et al. (Attorney Docket No. 13-008-00-NZ), filed 19 Feb. 2013, which is incorporated by reference herein.

### BACKGROUND

When a network device is going to be added or replaces an existing network device, the network device needs to be configured in order to function properly in the network. Typically, this is a manual process. For example, a network engineer plugs in a network device locally on his or her desk and then configures the device by entering various Command Line Interface (CLI) commands until the device can be coupled to the network. The network device may then be coupled to the network and additional commands entered until the network device is configured.

The connecting of the network device to the network may necessitate the network engineer traveling to the location where the network device will reside. This travel can be costly and the network engineer may be required to stay at that location while any issues with the configuration of the network device are determined and corrected, thereby further increasing costs.

### SUMMARY

A need has arisen for a solution that allows creation of a network device configuration prior to connecting the device to the network and allows the network device to configure itself based on the network device configuration.

Embodiments are configured to allow creation, generation, etc., of a configuration for a new network device that is not present on a network at the time the configuration is created. Information associated with the configuration may be sent to a network device that the new network device will be coupled thereto. The new network device on power up may then receive the information associated with the configuration. Embodiments are configured for automatic configuration upon adding a new network device to a network. In some embodiments, the automatic configuration is based on the location of the new network device in the network. For example, the configuration information and the associated configuration received and used to configure the new network device may be based on location of the new network device relative to a device that the new network device is coupled thereto. Embodiments support creation of configurations for multiple devices that are to be added to a network prior to adding the multiple devices to the network. For example, the multiple devices can be added to a network one by one, or in some combination and automatically configured.

An embodiment is directed to a method for setting up a configuration for a new network device. The method includes sending from an electronic system, a configuration associated with a device that is to be newly added to a network and sending a communication. The communication may include an identifier associated with the device that is to be newly added to the network and a location of the configuration associated with the device that is to be newly added to the network. In some embodiments, the device may not be a replacement for a failed device. In some embodiments, the identifier associated with the device is selected from the group consisting of a model identifier, a MAC address, and a port enumeration. In some embodiments, the communication further comprises an indicator associated with a location within the network where the device that is to be newly added to the network is to be coupled. In some embodiments, the configuration associated with the device is created manually. In some embodiments, the configuration associated with the device is generated from a cloning process. In some embodiments, the configuration associated with the device is not associated with another device that is coupled to the network. In some embodiments, the configuration associated with the device comprises a software release. In some embodiments, the configuration associated with the device further comprises a license. In some embodiments, the configuration associated with the device is validated via a simulation.

Another embodiment is directed to a method for configuring a new network device. The method includes receiving, at an electronic system, an identifier associated with the electronic system from a device within a network. In some embodiments, the electronic system is unconfigured and wherein the electronic system is coupled to the network for a first time. The method further includes receiving a location of a configuration associated with the electronic system. The configuration associated with the electronic system was created prior to coupling of the electronic system to the network. The method further includes sending a request for the configuration based on the location of the configuration associated with the electronic system and receiving the configuration associated with the electronic system. The method further includes configuring the electronic system based on the configuration associated with the electronic system. In some embodiments, the receiving of the identifier associated with the electronic system is based on a location of the electronic system within the network. In some embodiments, the electronic system is not replacing a failed electronic system. In some embodiments, the method further includes signaling a lighting element according to a first pattern during the configuring. In some embodiments, the method further includes signaling the lighting element according to a second pattern in response to a configuration failure.

Another embodiment is directed to a system for provisioning of a device. The system includes a configuration module configured for creating a configuration associated with a first device that is to be newly added to a network and a communication module configured for sending to a second device, an identifier associated with the first device that is to be newly added to the network and further sending a location of the configuration associated with the first device that is to be newly added to the network.

In some embodiments, the configuration module is configured for validating the configuration. In some embodiments, the configuration module is configured for simulating a configuration operation based on the configuration associated with the first device. In some embodiments, the configuration module is configured for creating the configuration associated with the first device that is to be newly added to the network based on a cloning operation. In some embodiments, the first device is configured to automatically configure the first device based on the configuration associated with the first device. In some embodiments, the method further includes a storage module configured for storing the configuration associated with the first device.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIG. 1 shows an exemplary operating environment in accordance with some embodiments.

FIG. 2 shows exemplary communications during setup of a configuration in accordance with some embodiments.

FIG. 3 shows exemplary communications during configuration of a device newly added to a network in accordance with some embodiments.

FIG. 4 shows an exemplary flow diagram of a process for setting up a configuration for a new network device in accordance with some embodiments.

FIG. 5 shows an exemplary flow diagram of a configuration process for a new network device in accordance with some embodiments.

FIG. 6 shows a block diagram of an exemplary computer system in accordance with some embodiments.

FIG. 7 shows a block diagram of another exemplary computer system in accordance with some embodiments.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended Claims. Furthermore, in the following detailed description of various embodiments, numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits have not been described in detail as not to unnecessarily obscure aspects of the claimed embodiments.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “converting,” “transmitting,” “storing,” “determining,” “sending,” “querying,” “providing,” “accessing,” “associating,” “configuring,” “initiating,” “customizing”, “mapping,” “modifying,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

A need has arisen for a solution that allows creation of a network device configuration prior to connecting the device to the network. Moreover, a need has arisen to allow the network device to configure itself when the network device is added to the network.

One solution was to create a pre-made configuration file and manually load it on the network device. This typically requires the input and presence of a network engineer with substantial cost and time.

Another solution relies on provisioning the device by associating a configuration with a unique identifier that belongs to the device such as a MAC address or unique certificate. This approach requires the unique identifier to be present on the new device, and the unique identifier to be known in advance by the network engineer. These limitations may not be easily overcome, and in addition limit the flexibility of device installation, requiring each specific device to be coupled in the correct location in the network. Furthermore, with this solution, each specific device will receive its associated configuration when it is coupled to the network, regardless of whether it has been coupled in the correct location, which can result in network outage and security concerns.

Embodiments are configured to allow creation, generation, etc., of configurations for new network devices that are not present on a network at the time that the configuration is created. Information associated with the configuration may be sent to a network device that the new network device will be coupled thereto. The new network device on power up may then receive the information associated with the configuration, e.g., from the network device that previously received the information associated with the configuration. Embodiments are configured for automatic configuration upon adding a new network device to a network. In some embodiments, the automatic configuration is based on the location of the new network device in the network. For example, the configuration information and the associated configuration received and used to configure the new network device may be based on location of the new network device relative to a device that the new network device is coupled thereto. Embodiments support creation of configurations for multiple devices that are to be added to a network prior to adding the multiple devices to the network. For example, the multiple devices can be added to a network one by one, or in some combination and automatically configured.

Embodiments are configured to provide for the unique identification of a new device that is not yet part of the network, through implicit or explicit signaling of the physical or logical location in the network that the new device is to be coupled to. Implicit signaling may be achieved through reception of messages from one or more physically attached neighboring devices. Explicit signaling may be achieved through reception of messages from any device within the network, which contain appropriate topological information so as to uniquely identify the new device that receives those messages, e.g., a hop-count relative to some defined anchor-point within the network, or a topological graph.

Embodiments may further allow for simplified network upgrades. For example, a network engineer may create a configuration for a new network device and the physical setup of the new network device may be performed by a non-network engineer. After the physical setup is complete, the new network device can automatically configure itself based on the configuration created by the network engineer.

As another example, branch office upgrades may be simplified. A network engineer would normally have to travel to each branch to setup network equipment for network upgrades, expansion, etc. However, embodiments enable creation of a configuration, delivery of the new network device to the branch office, and coupling of the new network device to the network by someone other than the network engineer (e.g., a less skilled individual). The new network device will then be able to automatically configure itself, thereby saving the costs and time associated with a network engineer traveling to a site and performing network equipment installation.

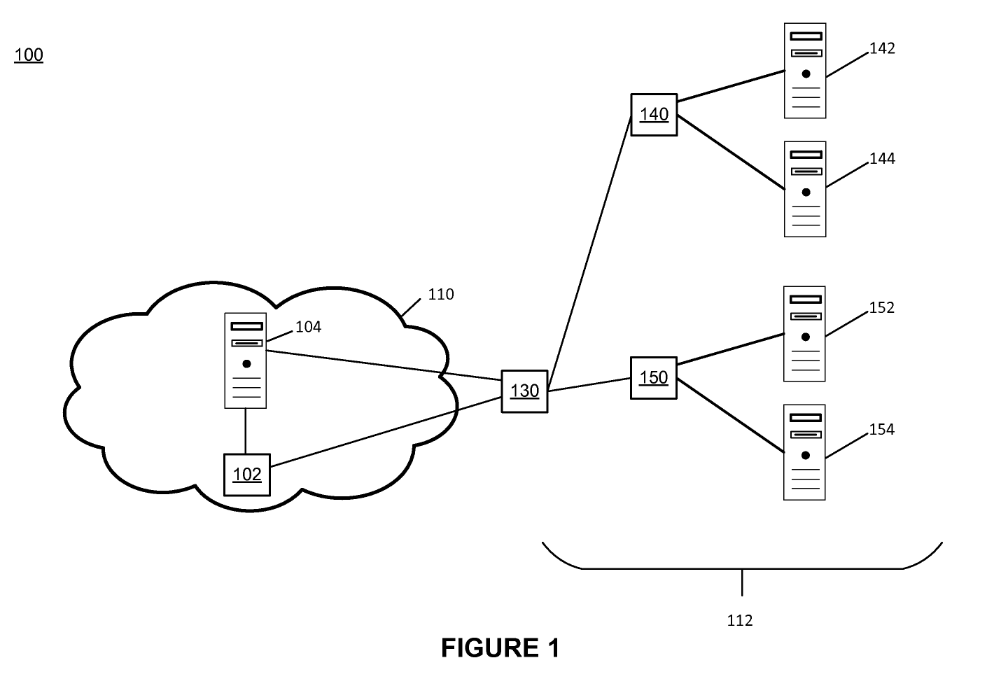

FIG. 1 shows an exemplary operating environment in accordance with some embodiments. The exemplary operating environment 100 includes networks 110, 112, network devices 130-150, and computing devices 142-144 and 152-154. Network 110 includes computing devices 102 and 104. Computing devices 142-144 are coupled to network device 130 via network device 140. Computing devices 152-154 are coupled to network device 130 via network device 150. Computing devices 102-104 are coupled to network device 130 via network 110. It is appreciated that any number of computing devices (e.g., computing devices 102-104, 142-144, 152-154, etc.), network devices (e.g., network devices 130-150), etc., may be a part of an exemplary operating environment 100. Exemplary operating environment 100 may include more or fewer computing devices and more or fewer networking devices than shown.

Before proceeding to further describe the various components of an operating environment 100, it is appreciated that the computing devices 102-104, 130-150, 142-144, and 150-152 are exemplary and are not intended to limit the scope of the embodiments. For example, an operating environment 100 may include other devices, such as workstations, modems, printers, bridges, hubs, voice over internet protocol (IP) telephones, IP video cameras, computer hosts, etc.

The computing devices 102-104, 142-144, and 150-152 may be any of a variety of computing devices including, but not limited to, computers, servers, desktop computers, laptops, tablets, mobile devices, smartphones, printers, fax machines, etc.

The network devices 130-150 may be a hub, a switch, a gateway, a router, a wireless router, a wireless access point, a camera, a thermostat, a smoke detector, etc. The network device 130-150 may be operable to perform various networking functions including Network Address Translation (NAT), Dynamic Host Control Protocol (DHCP), etc. In some embodiments, the network devices 130-150 may store information associated with neighboring network devices. For example, network device 130 is a neighbor of network devices 140 and 150. As another example, the network device 130 may store the position of its immediate neighbors. In some embodiments, the network device 130 may be a router and network devices 140-150 may be switches.

In some embodiments, computing device 102 may be configured for storage of a configuration. The configuration may include a configuration file, a software release (e.g., executable, installation file, firmware, etc.), software release information, license information, etc. The computing device 102 may be a storage device, a network device, cloud storage, etc. In some embodiments, the storage of the computing device 102 may include a Universal Service Bus (USB) memory stick, flash card, etc. configured for storing a configuration. In some embodiments, the computing device 102 may be a Linux based device.

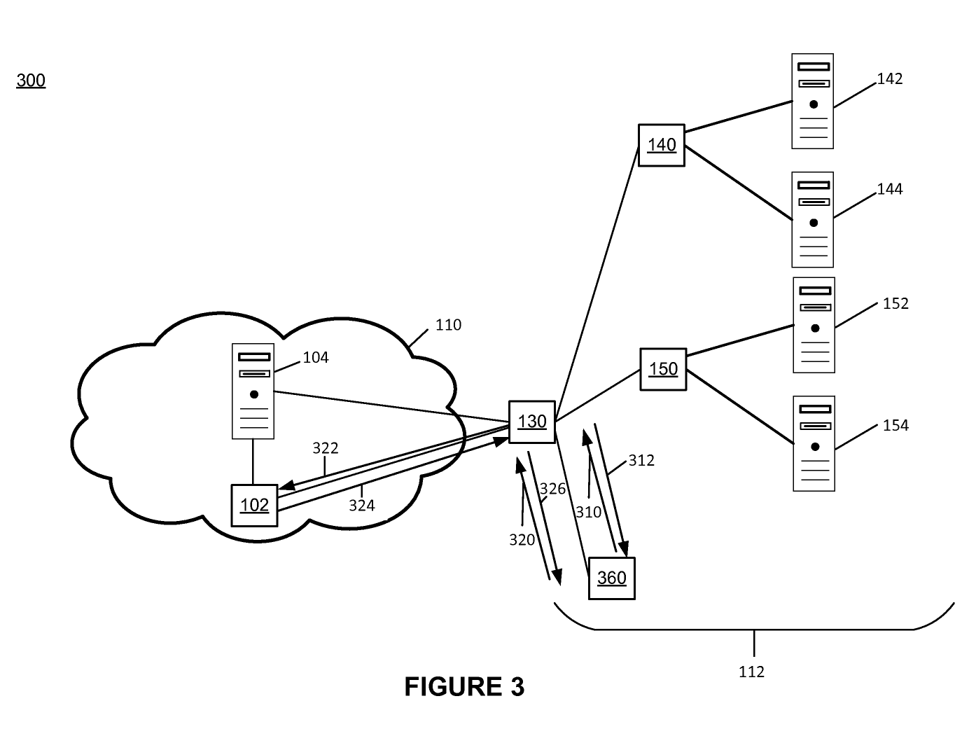

In some embodiments, the computing device 102 may be on a different network as the network device to be added (e.g., new network device 360 in FIG. 3). However, it is appreciated that the computing device 102 may be on the same network as the network device to be added (not shown). For example, the computing device 102 may be on the same network as the new network device to be added in an embodiment where network 112 and 110 are part of the same network (not shown).

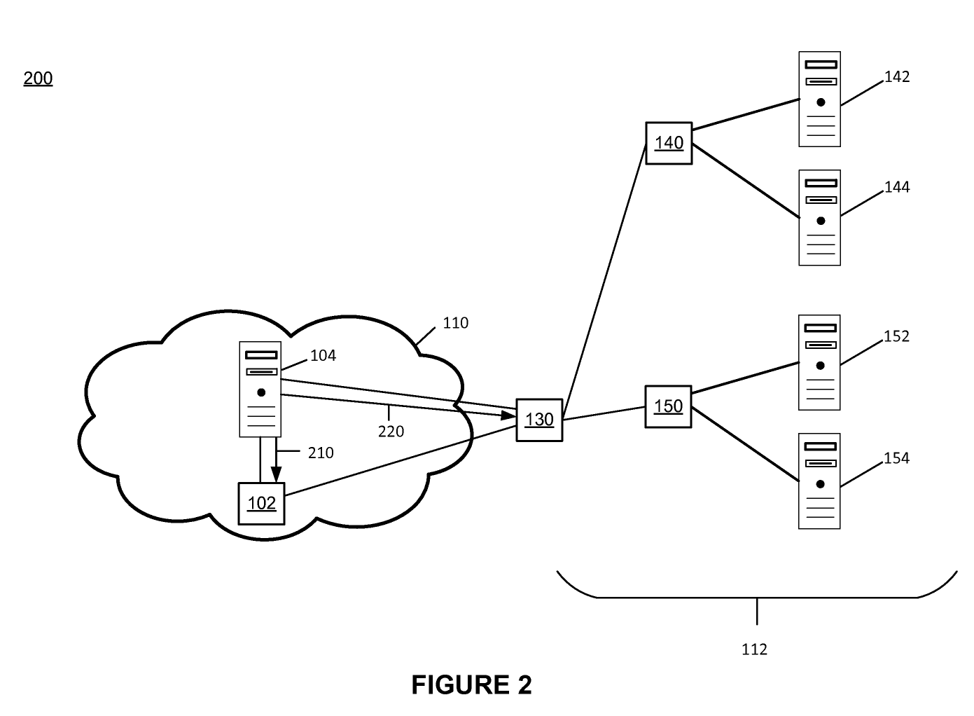

FIG. 2 shows exemplary communications during the setup of a configuration in accordance with some embodiments. Diagram 200 includes networks 110, 112, network devices 130-150, and computing devices 142-144 and 152-154. The exemplary communications of FIG. 2 may create a configuration for a first network device to be added to the network and configure a second network device for sending information associated with the configuration of the first network device. The first network device may be a network device that is not yet part of a network and/or a network device that will be added to the network in the future. Elements of FIG. 2 with similar element numbers to those of FIG. 1 may operate in a substantially similar manner.

In some embodiments, the computing device 104 is used to generate a configuration for a network device that is not currently part of the network 112. The network device that is not currently part of the network 112 may be a device that has yet to be added or will be added at some point in the future.

The computing device 104 sends a configuration message 210 to the computing device 102. In some embodiments, the computing device 102 is configured for storage of a device configuration. In some embodiments, the computing device 102 stores the contents of the configuration message 210 in a storage location for backups. The configuration data of the configuration message 210 may be stored in a directory of the storage of the computing device 102. For example, the configuration information may be stored in a newly created directory associated with the network device (e.g., a new network device 360) to be added to the network in the backup directory of the computing device 102. In some embodiments, the computing device 104 may be configured to edit, change, update, etc., a configuration stored by the computing device 102.

In some embodiments, the configuration message 210 comprises a configuration file, software release file, a license file, etc. The configuration file, the software release file, and the license file may each include one or more files and/or may be compressed files. In some embodiments, the software release and/or the license file may be optional. In some embodiments, the configuration file is a text file including network parameters (e.g., IP address, subnet mask, gateway, enabled features, etc.). The configuration file may further include commands and scripts. The contents of the configuration message 210 may be stored in the computing device 102 for access by a network device that is going to be added to network 112. In some embodiments, additional files copied into a configuration directory associated with the new device may also be received by the new network device. The additional files may include Graphical User Interface (GUI) application files or script files that may be used in addition to the standard configuration files. In some embodiments, a node configuration entry or node entry is created with a specific node name for the network device to be added on computing device 102. The node entry may then be populated with configuration data via configuration message 210.

In some embodiments, the configuration message 210 may include a “stub” or “foundation” configuration created for particular models of devices. For example, the stub configuration may apply to routers or a particular model of router, while different stub configurations could apply to switches. The stub configuration could relate to particular security features or other aspects of the particular hardware devices (e.g., PoE settings for PoE capable devices).

In some embodiments, the configuration message 210 may include a configuration that is based on cloning of another configuration. The cloned configuration may include a configuration file, a software release file, and a license file, that were copied from another device. For example, a configuration of a router currently in use may be cloned and modified for use with a new router to be added to the network. As another example, when a new branch office is to be added, the existing configurations from an existing branch office may be cloned and customized. The customization may include updating the IP address and VLANs according to the network of the new branch office. Cloning simplifies the process because a user would not have to specify the exact configuration file, exact software release, and/or exact license. In some embodiments, the cloning process is configured to modify, change, etc., the hostname and/or one or more unique identifiers (e.g., MAC address) of the cloned device for the new configuration to prevent potential conflicts of these identifiers within the network.

The configuration data of a configuration message 210 may further have been created and validated via simulation of the configuration commands, scripts, etc., of configuration message 210. The simulation may allow selection of a network device model or a particular network device and allow simulating of a CLI of a particular network device. The simulation may allow commands relevant to the type of device being provisioned, as well as commands to view the current configuration states to be executed. The simulation may allow a user to experience configuring a live device even though the device is not yet part of the network. The commands, scripts, etc., executed in the simulation may be output to a configuration file. In some embodiments, the interactive simulation configuration can be used in conjunction with a plain-text configuration file.

In some embodiments, the simulation allows selection of a device type for the configuration to be validated or tested against. For example, the simulation may allow command entry and display of a message when an illegal or improper command was entered. The simulation may further be used to verify that a configuration (e.g., cloned, created manually, created from a template, etc.) is proper and error free.

The computing device 104 sends a notification message 220 to a network device 130. The network device 130 may be referred to as a neighboring device based on the proximity of the network device 130 to the location where a new network device will be coupled. For example, the new network device will be coupled to the network device 130. In some embodiments, the new network device will be coupled directly to the network device 130.

The notification message 220 may include a hostname and a location of a configuration. The notification message 220 may further include the port, connector, etc., of network device 130 where a new or future device will be coupled. For example, the notification message 220 may further include a hostname for a new device added to network 112, location information for a configuration stored on computing device 102, and an indicator that a new device will be coupled to port three of network device 130. In some embodiments, one or more ports may be configured to “expect” coupling of a new network device.

In some embodiments, the one or more ports may be configured to expect coupling of a particular device model. The notification message 220 may include a unique identifier for a particular device model that is expected to appear on a particular port. If the particular device model is not coupled to the one or more ports, the network device 130 may not send configuration information to the device coupled to network device 130 on the one or more ports and the configuration process may be aborted.

In some embodiments, the notification message 220 may include a unique identifier for a particular device that is expected to appear on a particular port. For example, the media access control (MAC) address. If the new network device does not have the unique identifier, the configuration or provisioning process may be aborted. This may be used when a MAC address is known as the time of purchase of a new network device.

For example, a head-office may expect shipment of three switches, only one of which is configured for Power over Ethernet (PoE). The MAC address or the particular device model may be used to ensure that the PoE switch is placed in the correct location in the network because the PoE switch configuration process will fail if it is not placed in the correct location based on the port where the MAC address or the particular device model is coupled to the network.

In some embodiments, the notification message 220 may include an enumeration of physical ports on the new network device that are expected to be in certain operational states. The enumeration may include which ports are to be link-up, link-down, and/or ports that can be in either state, or can describe other characteristics of the ports of the new network device, e.g., link speed, duplex setting, physical port description (e.g., Ethernet, copper Ethernet, fibre, fibre Small Form-factor Pluggable (SFP), particular SFP model number, etc.), etc. If the operational states of the ports on the new network device do not match those in the enumeration, the configuration or provisioning process may be aborted or delayed for a period of time until the ports are in the expected states. In some embodiments, the notification message 220 may include information that is to have been learned on particular physical ports of the new network device. For example, neighboring device information may be stored in the form of Link Layer Discovery Protocol Data Unit (LLDPDU) type-length-values (TLVs). If the new network device has not learned the expected neighboring device information on its ports, the configuration or provisioning process may be aborted or delayed for a period of time until the expected neighboring device information has been learned. These measures may help to ensure against damage to the network if the new network device has not been coupled in the manner expected by the network engineer.

In some embodiments, the hostname for the new device and the configuration location information may be configured on the network device 130 via a remote command, command line interface (CLI), etc. The hostname of the new device and the configuration location information may be configured on multiple network devices (e.g., via a unified CLI). In some embodiments, the hostname of the new device and the configuration location information may be configured on multiple network devices simultaneously via a unified CLI. Various commands may thus be used to apply a notification message 220 to multiple neighboring network devices at one time. In some embodiments, the same information from the notification message 220 is configured on the multiple devices via a single command.

FIG. 3 shows exemplary communications during configuration of a device newly added to a network in accordance with some embodiments. Diagram 300 includes networks 110 112, network devices 130-150, computing devices 142-144 and 152-154, and a new network device 360. The exemplary communications of FIG. 3 may be performed by a new network device 360 to configure itself (e.g., automatically) upon being added to a network. Elements of FIG. 3 with similar element numbers to those of FIG. 1 may operate in a substantially similar manner.

In some embodiments, the new network device 360 may be a network device that is new from the manufacturer, reseller, etc., new to the customer, or re-deployed from another part to the network. In some embodiments, the network device 360 may replace a failed network device (not shown). The new network device 360 may not have been previously configured.

In some embodiments, upon coupling the network device 360 to a network device 130 and powering up, startup, boot up, etc., the network device 360 may send a startup message 310 to the network device 130. The startup message 310 may include an indicator that new network device 360 is not configured. In some embodiments, the new network device 360 may start in a special mode or with a particular protocol and signal one or more neighboring devices (e.g., the network device 130).

In some embodiments, the network device 130 responds to the startup message 310 with a configuration information message 312. The configuration information message 312 may include a hostname for the new network device 360 and location of configuration information. For example, the configuration information message 312 may include a hostname for the new network device 360 to configure itself with and location information of a configuration for the new network device 360 that is stored on computing device 102. As another example, the location information may include Virtual Local Area Network (VLAN) information and an IP address of computing device 102. In some embodiments, the network device 130 sends a configuration message 312 upon detection of coupling and/or powering up of the new network device 360 without receiving startup message 310. For example, the network device 130 may send the configuration message 312 based on an electrical signal received as part of physical cable connection between the network device 130 and the new network device 360.

In some embodiments, the configuration information message 312 is sent based on the coupling of the new network device 360 to a particular port of the network device 130. In some embodiments, the configuration information message 312 is sent over a private VLAN. In some embodiments, the new network device 360 may receive particular packets as part of configuration information message 312 that causes the new network device 360 to enter a particular mode (e.g., Safe State). In some embodiments, the startup message 310 and configuration information message 312 may include hello Bridge Protocol Data Unit (BPDU) packets, which are sent in a secure VLAN, which is resistant to attack by external actors. In some embodiments, the message 312 includes a ‘hello’ message with the hostname of the device last coupled to the port that the new network device 360 is coupled.

In some embodiments, the configuration information message 312 may not be sent when the new network device 360 fails to match a particular device model or have a particular unique identifier (e.g., MAC address). In some embodiments, the new network device 360 may then timeout after a period of not receiving the configuration information message 312.

In some embodiments, the new network device 360 is configured to resolve any mismatched information received from several nearby or neighboring network devices.

The new network device 360 may configure its hostname based on the hostname received from network device 130. The new network device 360 may send a configuration request message 320 to a network device 130. The configuration request message 320 may include a request for a configuration that is based on the configuration location information of the configuration information message 312.

The network device 130 may then send the configuration request message 320 as a message 322 to computing device 102. In some embodiments, based on receiving, the ‘hello’ message in message 312, the new network device 360 may send a configuration request message 320.

The computing device 102 may respond to the message 322 by sending a configuration message 324 to a network device 130. The configuration message 324 may include a configuration, which may include a configuration file, software release file, and/or a license file, as described above.

The network device 130 may then send the configuration message 324 as a configuration message 326 to the new network device 360. The new network device 360 may configure itself (e.g., automatically) based on the configuration within the configuration message 326. In some embodiments, the new network device 360 may reboot itself before, during, or after configuration. For example, the network device 360 may install a software release and license information from the configuration message 326, reboot, and execute, apply, install, etc., a configuration file. As another example, the configuration file may include network settings, power settings, commands for execution, etc.

In some embodiments, the configuration process copies the contents of a provisioned node directory from the computing device 102 to the file system (e.g., flash file system) of the new network device 360. In some embodiments, at the end of the configuration process, the new network device 360 reboots and begins regular operation within the network, as per the configuration files that the new network device has received. In some embodiments, an additional step in the configuration or provisioning process includes executing or running a license certificate. Embodiments may thus allow removal of a new network device from a shipping box, coupling to a network, and automatic configuration of the new network device.

In some embodiments, the new network device 360 may display different indicator lighting patterns (e.g., one or more light-emitting diode (LED) light, display screens, etc.) based on different stages of configuration. The indicator lights of new network device 360 may include link, activity, other status indicators, etc. For example, a first pattern of indicator lights may be used when the new network device 360 is configuring or provisioning itself. As another example, the indicator lights may turn on one by one, at a rate of two per second and in numerical order, and when all of the indicator lights are on, the indicator lights are turned off. Then the indicator lights may be turned on one by one, at a rate of two per second in reverse numerical order, and when all of the indicator lights are on, the indicator lights are turned off. The aforementioned lighting process may be repeated while the new network device 360 is performing a configuration process. After the configuring or provisioning is complete, the indicator lighting may return to regular operation. In some embodiments, the configuring or provisioning is complete upon a reboot and the indicator lighting returns to regular operation.

In some embodiments, a second pattern of indicator lights may be used when the configuration of the new network device 360 has failed. For example, the second pattern may include the indicator lights alternating on for 1.5 seconds and off for 1.5 seconds. The configuration of the new network device 360 may fail when the new network device 360 did not receive a hostname, configuration location information, is not able to communicate with the storage including the configuration information, and/or cannot retrieve the configuration from the storage. In some embodiments, a command may be used to turn off the indicator lights pattern and resume the normal function of the indicator lights.

Additional devices (e.g., network devices, computing devices, etc.) may then be coupled to the new network device 360 after configuration. For example, additional computing devices can be coupled to the new network device 360. As another example, the new network device 360 could be a switch, which is added so that additional computing devices can be coupled to network 112.

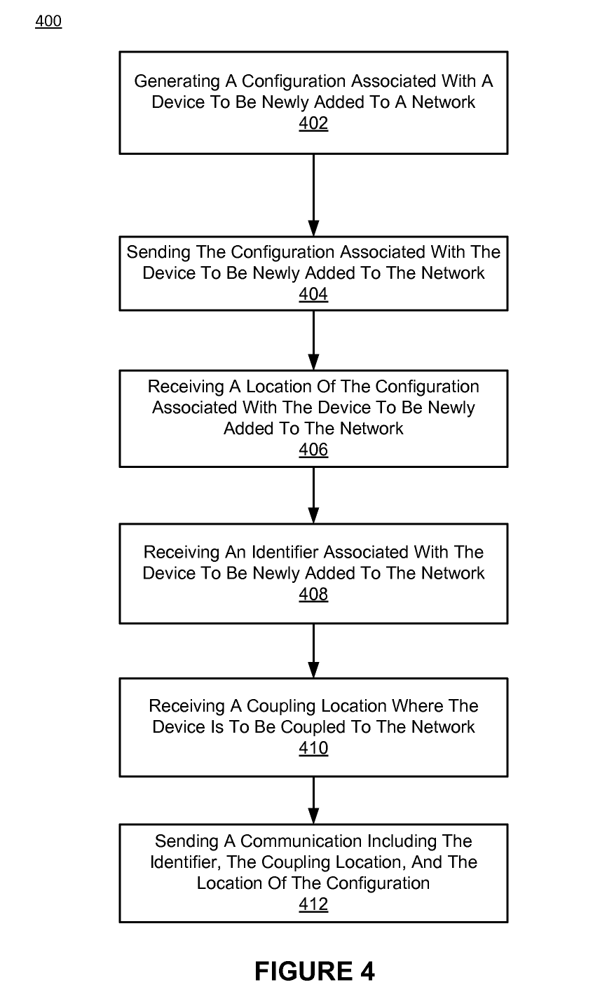

FIG. 4 shows an exemplary flow diagram of a process for setting up a configuration for a new network device in accordance with some embodiments. In some embodiments, FIG. 4 depicts a process 400 for storing a configuration for and configuring a neighboring device for communicating with a new network device. For example, process 400 may be used to send a currently operating network device the configuration information associated with a new device to be added to a network. Elements of FIG. 4 with similar element numbers to those of FIG. 1 may operate in a substantially similar manner.

At block 402, a configuration associated with a device to be newly added to a network is generated, as described above. In some embodiments, the device is not a replacement for a failed device. In some embodiments, the configuration associated with the device may be generated from a cloning process, created manually, etc. In some embodiments, the configuration associated with the device is validated via a simulation before storing of the configuration. In some embodiments, the configuration associated with the device comprises a software release. In some embodiments, the configuration associated with the device may further comprise a license. In some embodiments, the configuration associated with the device is not associated with another device that is coupled to the network.

At block 404, the configuration associated with a device to be newly added to a network is sent, as described above. The configuration may be sent from a computing device (e.g., computing device 104, a server, a network device, etc.) to a computing device (e.g., computing device 102) with storage configured for storing the configuration.

At block 406, a location of the configuration associated with the device that is to be newly added to the network is received, as described above. In some embodiments, the location of the configuration is determined upon successful sending of the configuration associated with the device to be newly added to the network to a device comprising storage. In some embodiments, the location of the configuration is received from a device (e.g., computing device 102) that has stored the configuration.

At block 408, an identifier associated with a device to be newly added to a network is received, as described above. In some embodiments, the identifier may be received from a program, a module, etc., that generated the identifier (e.g., automatically generated the identifier). In some embodiments, the identifier may be customized, selected, etc., by a user. In some embodiments, the identifier includes a hostname for the device to be newly added. In some embodiments, the identifier associated with the device may further comprise a model identifier associated with the device, a MAC address, a port enumeration, etc.

At block 410, a coupling location where the device is to be coupled to the network is received. In some embodiments, the coupling location may be received from a program, a module, etc., that determined an available port on a network device (e.g., network device 130). In some embodiments, the coupling location may be customized, selected, etc., by a user. In some embodiments, a command is sent to an existing network device that a new network device should be expected on or coupled to a particular port. The command may program the existing device to send a message to the next device that is coupled to a particular port that indicates the hostname of the newly coupled device. In some embodiments, the coupling location may be used to uniquely identify a new network device by location of the new network device within the network topology. In some embodiments, the coupling location includes an indicator associated with a location within the network where the network device that is to be newly added to the network is to be coupled.

At block 412, a communication including the identifier, the coupling location, and the location of the configuration is sent, as described herein. In some embodiments, the communication is sent from a computing device (e.g., computing device 104) that was used to generate the configuration. The communication including the identifier, the coupling location, and the location of the configuration may be sent to a device that will be a neighbor of the device newly added to the network.

Embodiments support the configuration of multiple existing or neighboring devices for sending configuration information to a new network device. In some embodiments, the configuration information is sent to one or more network devices simultaneously (e.g., via a unified CLI command).

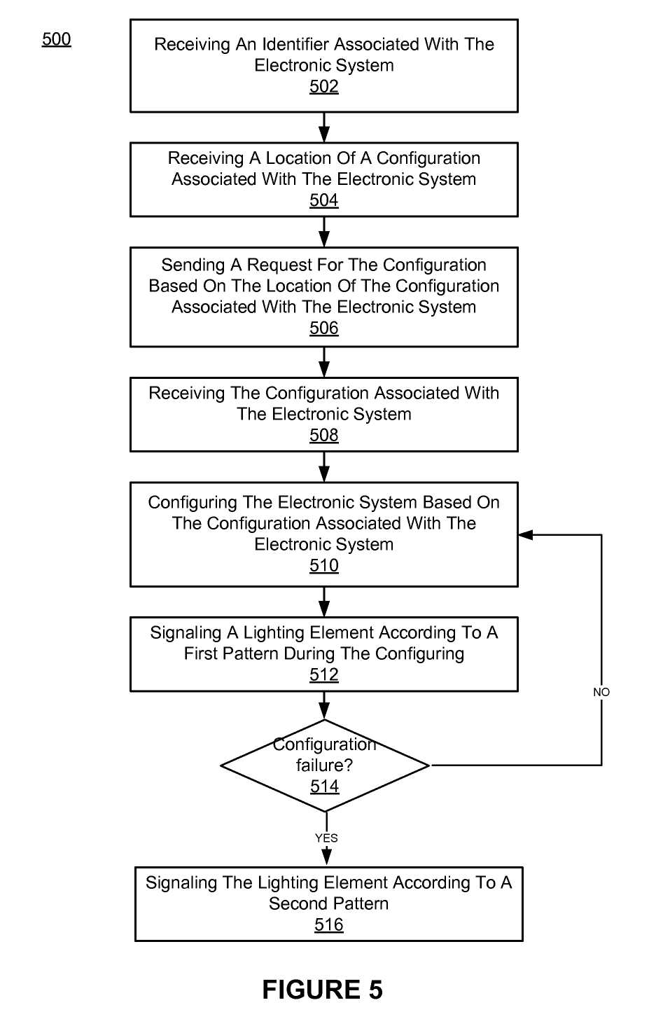

FIG. 5 shows an exemplary flow diagram of a configuration process for a new network device in accordance with some embodiments. In some embodiments, FIG. 5 depicts a process 500 for receiving configuration information and performing a configuration process based on the configuration information. For example, a newly added network device may start up and receive an identifier including a hostname and a location where a configuration is stored. The newly added device may then configure itself upon requesting and receiving the configuration.

At block 502, an identifier associated with an electronic system is received, as described herein. In some embodiments, the identifier may be received at a new network device (e.g., network device 360) from a neighboring network device. In some embodiments, the electronic system is unconfigured and the electronic system is coupled to a network for the first time. In some embodiments, the electronic system is a network device. In some embodiments, the electronic system is not replacing a failed electronic system. In some embodiments, the receiving of the identifier associated with the electronic system is based on a location of the electronic system within the network. For example, if the electronic system is coupled to the network in an incorrect or unexpected location, the identifier associated with the electronic system may not be received and the configuration or provisioning process may abort.

At block 504, a location of a configuration associated with the electronic system is received, as described herein. In some embodiments, the location of the configuration may be received at a new network device (e.g., network device 360) from a neighboring network device. In some embodiments, the configuration associated with the electronic system was created prior to coupling of the electronic system to the network. In some embodiments, the identifier and/or the location of the configuration may uniquely identify the electronic system by the location of the network device within the network topology.

At block 506, a request for the configuration based on the location of the configuration associated with the electronic system is sent, as described herein. In some embodiments, the request for the configuration is sent to a neighboring network device to be communicated to a storage device with the configuration. The request may be sent to a device (e.g., device 102) including storage with the configuration.

At block 508, the configuration associated with the electronic system is received, as described herein. In some embodiments, the configuration is received at a new network device (e.g., network device 360) from the storage device. In some embodiments, the electronic system may be directly coupled to a storage device, which may send the configuration to the electronic system.

At block 510, the electronic system is configured based on the configuration associated with the electronic system, as described herein. In some embodiments, the electronic system may automatically configure itself based on the configuration.

At block 512, a lighting element is signaled according to a first pattern during the configuring, as described herein.

At block 514, whether a configuration failure has occurred is determined. If a configuration failure has occurred, block 516 may be performed. If a configuration failure has not occurred, block 510 may be performed. In some embodiments, block 510 may be performed a predetermined number of times before the electronic system stops attempting to configure itself at block 510.

At block 516, the lighting element is signaled according to a second pattern in response to a configuration failure.

In some embodiments, the provisioning process (e.g., processes 400-500) may be used when a network device is removed and the replacement is to have a different configuration. For example, a configuration backup of the removed device could be cloned, the configuration edited, and the new network device added.

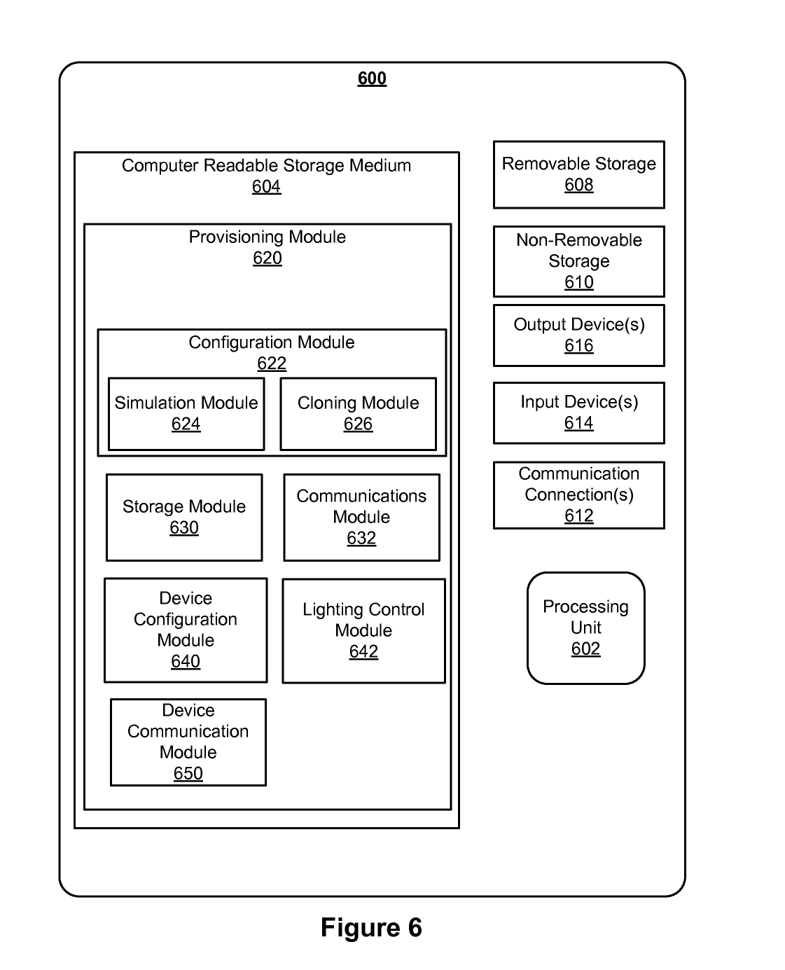

Referring now to FIG. 6, a block diagram of an exemplary computer system in accordance with some embodiments is shown. With reference to FIG. 6, an exemplary system module for implementing embodiments disclosed above, such as the embodiments described in FIGS. 1-5. In some embodiments, the system includes a general purpose computing system environment, such as computing system environment 600. The computing system environment 600 may include, but is not limited to, servers, desktop computers, laptops, tablets, mobile devices, and smartphones. In its most basic configuration, the computing system environment 600 typically includes at least one processing unit 602 and computer readable storage medium 604. Depending on the exact configuration and type of computing system environment, computer readable storage medium 604 may be volatile (such as RAM), non-volatile (such as ROM, flash memory, etc.) or some combination of the two. Portions of computer readable storage medium 604 when executed may perform name resolution and mapping functions to allow internal or private networks to use network addresses outside of private or internal network address ranges as specified by a network protocol.

Additionally in various embodiments, the computing system environment 600 may also have other features/functionality. For example, the computing system environment 600 may also include additional storage (removable and/or non-removable) including, but not limited to, magnetic or optical disks or tape. Such additional storage is illustrated by removable storage 608 and non-removable storage 610. Computer storage media includes volatile and nonvolatile, removable and non-removable media implemented in any method or technology for storage of information such as computer readable instructions, data structures, program modules or other data. Computer readable medium 604, removable storage 608 and nonremovable storage 610 are all examples of computer storage media. Computer storage media includes, but is not limited to, RAM, ROM, EEPROM, flash memory or other memory technology, expandable memory (e.g. USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by the computing system environment 600. Any such computer storage media may be part of the computing system environment 600.

In some embodiments, the computing system environment 600 may also contain communications connection(s) 612 that allow it to communicate with other devices. Communications connection(s) 612 are an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media as used herein includes both storage media and communication media.

Communications connection(s) 612 may allow the computing system environment 600 to communicate over various networks types including, but not limited to, fibre channel, small computer system interface (SCSI), Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that the communication connection(s) 612 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, the computing system environment 600 may also have input device(s) 614 such as keyboard, mouse, a terminal or terminal emulator (either directly connected or remotely accessible via telnet, SSH, HTTP, SSL, etc.), pen, voice input device, touch input device, remote control, etc. Output device(s) 2016 such as a display, a terminal or terminal emulator (either directly connected or remotely accessible via telnet, SSH, HTTP, SSL, etc.), speakers, LEDs, etc. may also be included.

In some embodiments, the computer readable storage medium 604 includes a provisioning module 620. The provisioning module 620 is configured for creating or generating a configuration for a device that is to be newly added to a network and configured for configuration (e.g., automatic) of the device. The provisioning module 620 includes configuration module 622, storage module 630, communication module 632, device configuration module 640, lighting control module 642, and device communication module 650.

In some embodiments, the modules may be distributed across one or more devices, including gateways, routers, name resolution devices, domain name servers, proxy devices, etc. In some embodiments, one or more of the modules may be executed, performed, etc., by a single device.

The configuration module 622 is configured for creating a configuration associated with a device that is to be newly added to a network. In some embodiments, the configuration module 622 is configured for creating the configuration associated with the device that is to be newly added to the network based on a cloning operation. In some embodiments, the device is configured to automatically configure the device based on the configuration associated with the device.

In some embodiments, the configuration module 622 may include a simulation module 624 and a cloning module 626. The simulation module 624 may be configured for simulating a configuration operation based on the configuration associated with the device. In some embodiments, the configuration module 622 may be configured for validating or determining errors in a configuration (e.g., via simulation module 624). The cloning module 626 is configured for cloning an existing configuration or configuration of an existing device, as described above. In some embodiments, the cloning module 626 may clone and automatically modify (e.g., changing unique attributes or values in the output configuration) the configuration.

The storage module 630 is configured for storing the configuration associated with the device. In some embodiments, the storage module 630 is configured for storing the configuration locally or on a remote device, as described above. In some embodiments, the storage module 630 is configured for determining a storage location for a configuration associated with the device.

The communication module 632 is configured for sending to a second device, an identifier associated with the device that is to be newly added to the network and a location of the configuration associated with the device that is to be newly added to the network.

The device configuration module 640 is configured for configuring a device based on a configuration associated with the device. The device configuration module 640 may automatically configure the device.

The lighting control module 642 is configured for signaling one or more lighting elements (e.g., LEDs, display screens, etc.) according to a first pattern during configuration and a second pattern in response to a configuration failure.

The device communication module 650 is configured for communication with other devices including receiving an identifier associated with the device and a location of the configuration associated with the device, as described above. The device communication module 650 is further configured for requesting and receiving a configuration from a storage device (e.g., storage module 630).

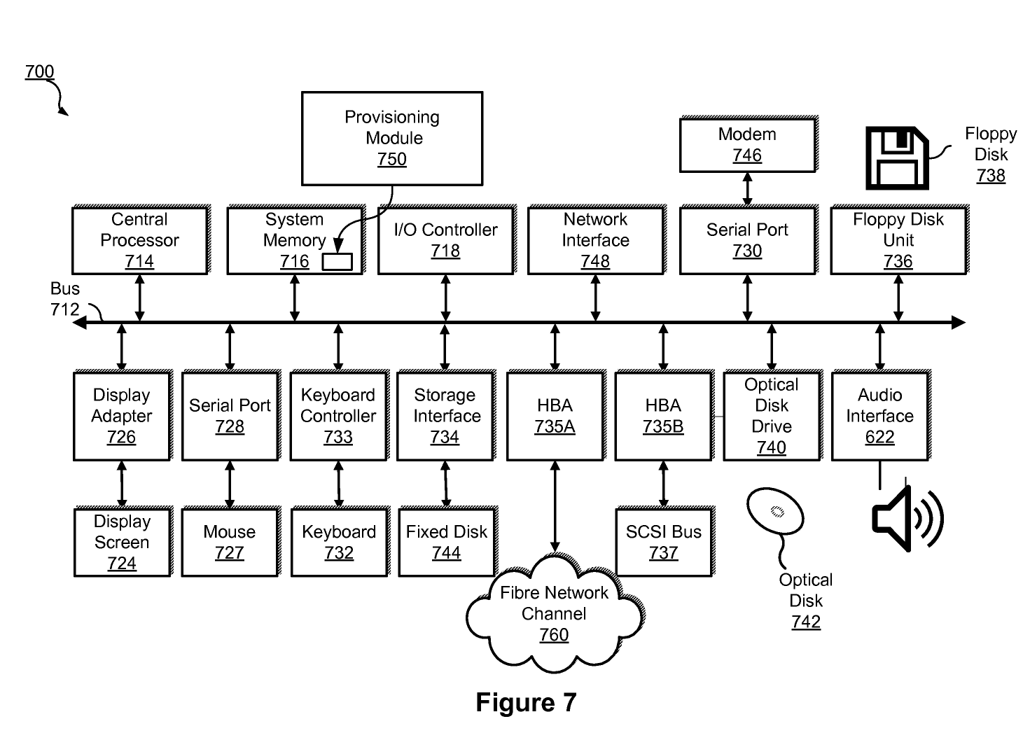

Referring now to FIG. 7, a block diagram of another exemplary computer system in accordance with some embodiments is shown. FIG. 7 depicts a block diagram of a computer system 700 suitable for implementing the present disclosure. Computer system 700 includes a bus 712 which connects the major subsystems of the computer system 700, such as a central processor 714, a system memory 716 (typically RAM, but which may also include ROM, flash RAM, or the like), an input/output controller 718, an external audio device, such as a speaker system 720 via an audio output interface 722, an external device, such as a display screen 724 via a display adapter 726, serial ports 728 and 730, a keyboard 732 (interfaced with a keyboard controller 733), a storage interface 734, a floppy disk drive 736 operative to receive a floppy disk 738, a host bus adapter (HBA) interface card 735A operative to connect with a Fibre Channel network 760, a host bus adapter (HBA) interface card 735B operative to connect to a Small Computer System Interface (SCSI) bus 737, and an optical disk drive 740 operative to receive an optical disk 742. Also included are a mouse 727 (or other point-and-click device, coupled to bus 712 via serial port 728), a modem 746 (coupled to bus 712 via serial port 730), and a network interface 748 (coupled directly to bus 712).

It is appreciated that the network interface 748 may include one or more Ethernet ports, wireless local area network (WLAN) interfaces, etc., but is not limited thereto. System memory 716 includes a provisioning module 750, which is configured for creating or generating a configuration for a device that is to be newly added to a network and configured for configuration (e.g., automatic) of the device. According to some embodiments, provisioning module 750 may include other modules for carrying out various tasks (e.g., modules of FIG. 6). It is appreciated that the provisioning mapping module 750 may be located anywhere in the system and is not limited to the system memory 716. As such, residing within the system memory 716 is merely exemplary and not intended to limit the scope of the embodiments. For example, parts of the provisioning module 750 may be located within the central processor 714 and/or the network interface 748 but are not limited thereto.

The bus 712 allows data communication between the central processor 714 and the system memory 716, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS), which controls basic hardware operation such as the interaction with peripheral components. Applications resident with computer system 700 are generally stored on and accessed via a computer readable medium, such as a hard disk drive (e.g., fixed disk 744), an optical drive (e.g., optical drive 740), a floppy disk unit 736, or other storage medium. Additionally, applications can be in the form of electronic signals modulated in accordance with the application and data communication technology when accessed via network modem 746 or network interface 748.

The storage interface 734, as with the other storage interfaces of computer system 700, can connect to a standard computer readable medium for storage and/or retrieval of information, such as a fixed disk drive 744. A fixed disk drive 744 may be a part of computer system 700 or may be separate and accessed through other interface systems. The network interface 748 may provide multiple connections to networked devices. Furthermore, a modem 746 may provide a direct connection to a remote server via a telephone link or to the Internet via an Internet service provider (ISP). The network interface 748 provides one or more connections to a data network, which may consist of any number of other network-connected devices. The network interface 748 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, not all of the devices shown in FIG. 12 need to be present to practice the present disclosure. The devices and subsystems can be interconnected in different ways than shown in FIG. 12. Code to implement the present disclosure can be stored in computer-readable storage media such as one or more of system memory 716, fixed disk 744, optical disk 742, or floppy disk 738. The operating system provided on computer system 700 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings.

What is claimed is:

1. A method comprising:
sending from an electronic system, a configuration associated with a device that is to be newly added to a network; and
sending a communication comprising:
an identifier associated with the device that is to be newly added to the network; and
a location of the configuration associated with the device that is to be newly added to the network.

2. The method as described in claim 1, wherein the device is not a replacement for a failed device.

3. The method as described in claim 1, wherein the communication further comprises an indicator associated with a location within the network where the device that is to be newly added to the network is to be coupled.

4. The method as described in claim 1, wherein the configuration associated with the device is created manually.

5. The method as described in claim 1, wherein the configuration associated with the device is generated from a cloning process.

6. The method as described in claim 1, wherein the configuration associated with the device is not associated with another device that is coupled to the network.

7. The method as described in claim 1, wherein the configuration associated with the device comprises a software release.

8. The method as described in claim 7, wherein the configuration associated with the device further comprises a license.

9. The method as described in claim 1, wherein the configuration associated with the device is validated via a simulation.

10. The method as described in claim 1, wherein the identifier associated with the device is selected from the group consisting of a model identifier, a MAC address, and a port enumeration.

11. A method comprising:
receiving, at an electronic system, an identifier associated with the electronic system from a device within a network, wherein the electronic system is unconfigured and wherein the electronic system is coupled to the network for a first time;
receiving a location of a configuration associated with the electronic system, wherein the configuration associated with the electronic system was created prior to coupling of the electronic system to the network;
sending a request for the configuration based on the location of the configuration associated with the electronic system;
receiving the configuration associated with the electronic system; and
configuring the electronic system based on the configuration associated with the electronic system.

12. The method of claim 11, wherein the receiving of the identifier associated with the electronic system is based on a location of the electronic system within the network.

13. The method of claim 11, wherein the electronic system is not replacing a failed electronic system.

14. The method of claim 11 further comprising:
signaling a lighting element according to a first pattern during the configuring.

15. The method of claim 14 further comprising:
signaling the lighting element according to a second pattern in response to a configuration failure.

16. A system comprising:
a configuration module configured for creating a configuration associated with a first device that is to be newly added to a network; and
a communication module configured for sending to a second device, an identifier associated with the first device that is to be newly added to the network and further sending a location of the configuration associated with the first device that is to be newly added to the network.

17. The system of claim 16, wherein the configuration module is configured for validating the configuration.

18. The system of claim 16, wherein the configuration module is configured for simulating a configuration operation based on the configuration associated with the first device.

19. The system of claim 16, wherein the configuration module is configured for creating the configuration associated with the first device that is to be newly added to the network based on a cloning operation.

20. The system of claim 16, wherein the first device is configured to automatically configure the first device based on the configuration associated with the first device.

21. The system of claim 16 further comprising:
a storage module configured for storing the configuration associated with the first device.
